(19) United States
(12) Patent Application Publication
(10) Pub. No.: US 2003/0180133 A1
(43) Pub. Date: Sep. 25, 2003

(54) Trolley for the movement on the ground, launching and beaching of boats

(76) Inventor: Anton Massimo Galluccio, Castellina In Chianti-Siena (IT)

Correspondence Address: YOUNG & THOMPSON, 745 SOUTH 23RD STREET 2ND FLOOR, ARLINGTON, VA, 22202

(21) Appl. No.: 10/388,487

(22) Filed: Mar. 17, 2003

(30) Foreign Application Priority Data
Mar. 19, 2002 (IT) AR2002A000012

(51) Int. Cl. B60P 1/02

(52) U.S. Cl. 414/495

(57) ABSTRACT

An apparatus shaped like a trolley with at least two front wheels (3), which are normally pivoting ones, two back wheels (2), a “U” shaped back structure with longitudinal shelves (18) and (19), and one front cross bar (5), with the “U” shaped structure and the front cross bar supplied with couplings (6) to raise the trolley, therefore a weighted beaching strap (20), supported by the stanchions (16) and (17) of the “U” shaped structure, and finally a rope (21) having at its mid point a float (23) forming, when out of the water, a downward half loop lower than the one formed by the beaching strap (20) so that the float (23) does not interact with it.

### BACKGROUND OF THE INVENTION

1. Field of the Invention

The invention relates to a trolley for the movement on the ground, as well as for launching and beaching of boats with the use of hoisting mechanisms to which it will be attached.

2. Description of the Related Art

At present launching and beaching of boats are performed with the use of hoisting mechanisms furnished with straps which are wrapped around the hull to raise it and then to move it from the ground to the water and vice versa.

This system implies that the water is absolutely calm for the centring of the hull between the straps, considering it must remain still until said straps are in tension and start to raise it. This determines a discontinous irregular use of said system as it is influenced by the wave motion of the water, unless one operates inside safeguarding structures, with all the evident disadvantages.

### SUMMARY OF THE INVENTION

The aim of the present invention is the creation of an apparatus which allows boats to be at least raised for their transfer from the ground to the water and vice versa, even in case of waves, and in the absence of safeguarding structures such as breakwaters and harbour walls, without causing damages to the hull.

Another aim is that of creating an apparatus that is capable of adapting to boats of different dimensions. A further aim is that of creating an apparatus that can be easily raised by hoisting mechanisms, such as cranes. One more aim is that of creating an apparatus which can be moved on land to bring the boat from the place of lifting, where it is left by the hoisting mechanism which has performed the beaching operation, to the shed or place in which it can be parked without creating an obstacle for other beaching operations or the launching of other boats.

The invention which has allowed to reach said results is put into practice by means of an apparatus shaped like a trolley supplied with at least two front wheels, which are normally pivoting ones, two back wheels, a “U” shaped back structure with longitudinal shelves and at least one front cross bar, with the “U” shaped structure and the front cross bar furnished with couplings for hoisting the trolley, therefore a weighted beaching strap supported by the stanchions of the “U” shaped structure, and finally a rope with a float at its mid point which forms a downward half loop, when outside the water, which is lower than the one formed by the beaching strap, so that the float does not interfere with it.

The said apparatus is advantageous because it can roll on the ground when on land, moving in relation to the crane that hoists it.

It is advantageous because it is furnished with the means for its quick and easily performed hooking and unhooking, as well as allowing the trolley to be detached from the hoisting mechanism only when the supporting bars or ropes are not under tension, as described here below.

It is furthermore advantageous because when the boat is in the water, it will pass with its bow over the float anchored on the rope until said float is wedged into the space between the stern of the boat and the foot of the engine therefore blocking its forward movement.

In these conditions the raising of the trolley determines the wrapping of the stern by the submersed strap and the resting of the bow of the boat on the support surface in the front part of the trolley, making the operation of securing the boat to a sling for its hoisting easy and quick.

### BRIEF DESCRIPTION OF THE DRAWINGS

Other advantages will become evident in the detailed description that follows, which refers to a production solution exemplified in a schematic way in the enclosed drawings, in which:

FIG. 1 is the view in the longitudinal direction of the trolley;

FIG. 2 is the top plan view of the trolley;

FIG. 3 is the side elevation view of the trolley;

FIG. 4 is the view in the longitudinal direction of the trolley when on land, on which a boat is loaded;

FIG. 5 is the view in the longitudinal direction of the trolley in the water, and of the boat floating on top of it;

FIG. 6 is the side elevation view of the trolley on land with a boat loaded on it;

FIG. 7 is the perspective view of the coupling apparatus of the trolley and of a bar with hoisting head close to it.

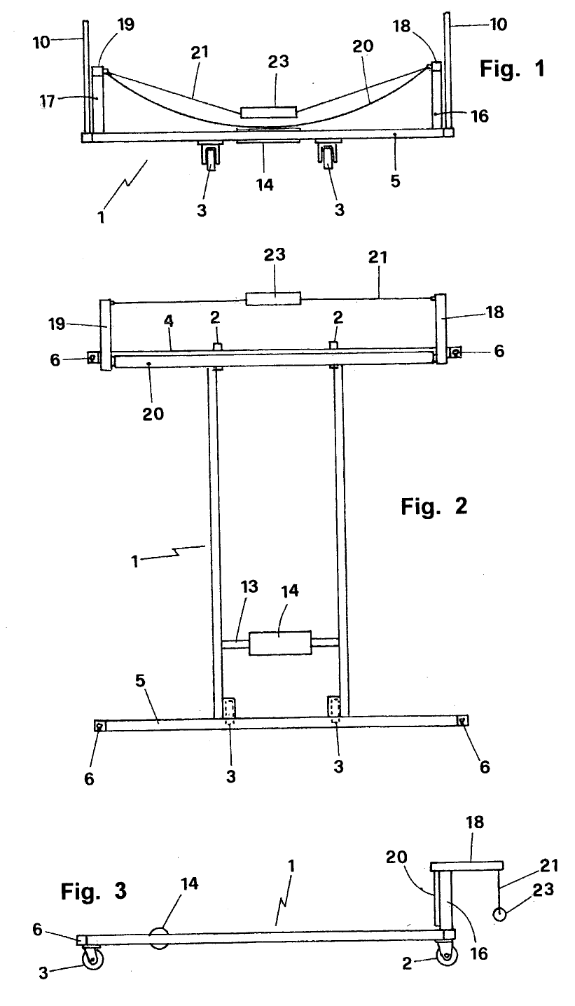

It is understood that the drawings are of a schematic type and their only scope is to exemplify the invention so that it can be easily understood, without in any way forming a limitation of it.

### DETAILED DESCRIPTION OF THE PREFERRED EMBODIMENT

In substance the invention therefore consists in a special trolley that is appropriate for carrying boats and in particular appropriate for launching them into the water and beaching them.

It includes a base or load bearing structure 1, furnished with two back wheels 2 and two front wheels 3, normally of the pivoting type, as well as of a front coupling, which is not reproduced in the drawings, on which to apply the traction required to move the trolley on land.

The trolley comprises two cross bars 4 and 5, towards the ends of which, therefore on the contours of the same trolley, are placed hoisting couplings 6. In the solution given only as an example in FIG. 7, each of the hoisting couplings 6 is made up of a body with a cross cavity 7, that is cylindrical on one end then narrows down at the top end until it is reduced to an opening 8. Said body has a cut 9 along one axis through which the hoisting bar or rope 10 passes, said bar or rope ending with an enlarged head 11, which can be housed in the cylindrical cavity 7 of body 6. This allows for the trolley to be detached from the hoisting mechanisms, as for example a crane, only when it is touching the ground and the enlarged head 11 of the bar or rope 10 exits the body 6 allowing in this way the bar or rope 10 to exit sideways through cut 9 and to be detached from the same trolley.

Towards the central front part of the trolley, normally on an appropriate cross bar 13, resting element 14 is positioned, it is created with soft material and made to support the bow of boat 15. Towards the back part of the trolley we can find stanchions 16 and 17 with shelves 18 and 19 towards their top. On stanchions 16 and 17 are fixed the ends of beaching strap 20, while on shelves 18 and 19 are fixed the ends of rope 21 with float 23 placed towards its middle part. Rope 21 whose length is shorter than that of beaching strap 20, so that they do not interfere with each other. Shelves 18 and 19 are parallel one to the other and oriented towards the back part of the trolley. They emerge from the vertical bars or stanchions 16 and 17 and are adequate to support rope 21, on whose central part float 23 is placed. The beaching strap 20 is weighted so that it does not float in the water and whose length allows its lower part, when free, to be close to the base of the trolley. When the trolley is placed into the water it sinks, while float 23, tied to shelves 18 and 19 by means of rope 21, remains floating. Boat 15, directed by mechanisms 10 which support the trolley, slips with its hull over float 23 against which foot 30 of engine 31 hits since it juts out in respect to the keel of boat 15 (FIG. 6). Float 23, by means of rope 21, transfers the load to shelves 18 and 19 and therefore to the structure of the trolley which stops it. At this point the raising phase begins. The trolley emerges gradually from the water and boat 15 comes into contact with beaching strap 20 which adapts its shape to the stern of the boat, while the bow is supported by the soft element 14 placed on front bar 5 or on an intermediate cross bar 13 of the trolley. Float 23 remains in contact with foot 30 of engine 31 during the lifting phase. When the hull rests on strap 20, rope 21 with float 23 loses tension and, when on land, it is possible to detach it only on one side and place it behind engine 31, in order not to prevent the launch which follows.

In an alternative solution the trolley can include a second couple of stanchions 16, 17 placed towards the front part of the trolley, joined by a second beaching strap adequate for the wrapping and supporting of the bow of boat 15.

In production the invention may undergo other variations which in any case will remain within the protection range of the following claims.

1. A trolley for the movement on the ground, for the launching and beaching of boats, which comprises a load bearing structure (1) with two back wheels (2) and two front wheels (3), characterised on its outline by coupling points (6) for its hoisting, towards the middle of the front part by a soft resting element (14), towards the back part by two stanchions (16) and (17) with two shelves (18) and (19), towards the top of which are respectively fixed a non floating beaching strap (20) and a rope (21) with float (23) near its middle, having a shorter length than that of beaching strap (20) so that they do not interfere.

2. The trolley, as claimed in claim 1, characterised by two cross bars, a front one (5) and a rear one (4) towards the ends of which the couplings (6) for hoisting the trolley are placed.

3. The trolley, as claimed in claim 1, characterised by the fact that each hoisting coupling is made up of a body (6) with a cross cavity, initially having a cylindrical shape (7), then narrowing towards the other extremity so as to form a hole (8), and by a cut (9) along its long axis, through which hoisting bar (10), terminating with an enlarged head (11) capable of being housed in the same cylindrical cavity (7), passes.

4. The trolley, as claimed in claim 1, characterised by two vertical stanchions (16) and (17) facing each other, having on their tops the couplings for the ends of the beaching strap (20) aimed at wrapping the stern of the boat (15), with said vertical stanchions placed at an appropriate distance to contain the same boat (15).

5. The trolley, as claimed in claim 1, characterised by two shelves (18) and (19) parallel to each other, aimed towards the back part of the trolley and emerging from the vertical stanchions (16) and (17) capable of sustaining rope (21) towards whose middle part a float (23) is placed.

6. The trolley, as claimed in claim 1, characterised by a beaching strap (20) whose length is such as to place its lower part, when free, close to the base of the trolley.

7. The trolley, as claimed in claim 1, characterised by the fact that the beaching strap (20) is weighted so that it does not float when in the water.

8. The trolley, as claimed in claim 1, characterised by the fact that the rope (21) has a length aimed to prevent the contact of the float (23) with the beaching strap (20).

9. The trolley, as claimed in claim 1, characterised by a second couple of stanchions (16) and (17) placed towards the front of the trolley, joined by a beaching strap capable of wrapping and supporting the bow of the boat (15).
